(19) United States
(12) Patent Application Publication
(10) Pub. No.: US 2025/0094775 A1
(43) Pub. Date: Mar. 20, 2025

(54) SYSTEMS AND METHODS FOR STATIC CACHED DECODING

(71) Applicant: QUALCOMM Incorporated, San Diego, CA (US)

(72) Inventors: Shaojie ZHUO, Richmond Hill (CA); Ramchalam KINATTINKARA RAMAKRISHNAN, North York (CA); Xiaopeng ZHANG, Toronto (CA); Yicheng LIN, Markham (CA); Chenzheng SU, Toronto (CA); Liang SHEN, Toronto (CA)

(21) Appl. No.: 18/468,574

(22) Filed: Sep. 15, 2023

(51) Int. Cl. G06N 3/0455

(52) U.S. Cl. CPC G06N 3/0455

(57) ABSTRACT

Cached decoding systems and techniques are described. A system (e.g., decoder) receives an input token (e.g., input vector). The system applies a projection tensor (e.g., a projection matrix) to the input token to generate a feature tensor (e.g., a key tensor or a value tensor). The system processes at least the feature tensor and at least one previous feature tensor using at least one attention calculation to generate an output token. The at least one previous feature tensor is retrieved from a buffer. The at least one previous feature tensor can be stored in the buffer after having been previously calculated based on application of the projection tensor to a previous input token (e.g., from a previous iteration before the iteration in which the input token is received).

### FIELD

The present disclosure generally relates to optimizing a machine learning model. For example, aspects of the present disclosure relate to systems and techniques for using static cached decoding to implement a static and/or optimizable inference graph for an auto-regressive transformer model.

### BACKGROUND

Machine learning models are useful for a variety of tasks, including image processing, computer vision, natural language processing, and generating content. In some examples, a machine learning model can process data across multiple iterations, with each iteration dependent upon at least one previous iteration. In some cases, processing data across multiple iterations in a machine learning model in this way can cause inefficiencies, such as duplicated computation(s) between iterations, limitation(s) to graph optimization, and/or potential compatibility issues with certain artificial intelligence (AI) accelerator frameworks that rely on static inference graphs.

### BRIEF SUMMARY

Systems and techniques for cached decoding are described. In various aspects, a system (e.g., decoder) receives an input token (e.g., input vector). The system applies a projection tensor (e.g., a projection matrix) to the input token to generate a feature tensor (e.g., a key tensor or a value tensor). The system processes at least the feature tensor and at least one previous feature tensor using at least one attention calculation to generate an output token. The at least one previous feature tensor is retrieved from a buffer. In some examples, the at least one previous feature tensor can be stored in the buffer after having been previously calculated based on application of the projection tensor to a previous input token (e.g., from a previous iteration before the iteration in which the input token is received).

According to some aspects, an apparatus for cached decoding is provided. The apparatus includes a memory and at least one processor (e.g., implemented in circuitry) coupled to the memory. The at least one processor is configured to and can: receive an input token; apply a projection tensor to the input token to generate a feature tensor; and process at least the feature tensor and at least one previous feature tensor using at least one attention calculation to generate an output token, the at least one previous feature tensor retrieved from a buffer, and the at least one previous feature tensor previously calculated based on application of the projection tensor to a previous input token.

In some aspects, a method of cached decoding is provided. The method includes: receiving an input token; applying a projection tensor to the input token to generate a feature tensor; and processing at least the feature tensor and at least one previous feature tensor using at least one attention calculation to generate an output token, the at least one previous feature tensor retrieved from a buffer, and the at least one previous feature tensor previously calculated based on application of the projection tensor to a previous input token.

In some aspects, a non-transitory computer-readable medium is provided that has stored thereon instructions that, when executed by one or more processors, cause the one or more processors to: receive an input token; apply a projection tensor to the input token to generate a feature tensor; and process at least the feature tensor and at least one previous feature tensor using at least one attention calculation to generate an output token, the at least one previous feature tensor retrieved from a buffer, and the at least one previous feature tensor previously calculated based on application of the projection tensor to a previous input token.

In some aspects, an apparatus for cached decoding is provided. The apparatus includes: means for receiving an input token; means for applying a projection tensor to the input token to generate a feature tensor; and means for processing at least the feature tensor and at least one previous feature tensor using at least one attention calculation to generate an output token, the at least one previous feature tensor retrieved from a buffer, and the at least one previous feature tensor previously calculated based on application of the projection tensor to a previous input token.

In some aspects, the apparatus is part of, and/or includes a wearable device, an extended reality device (e.g., a virtual reality (VR) device, an augmented reality (AR) device, or a mixed reality (MR) device), a head-mounted display (HMD) device, a wireless communication device, a mobile device (e.g., a mobile telephone and/or mobile handset and/or so-called “smart phone” or other mobile device), a camera, a personal computer, a laptop computer, a server computer, a vehicle or a computing device or component of a vehicle, another device, or a combination thereof. In some aspects, the apparatus includes a camera or multiple cameras for capturing one or more images. In some aspects, the apparatus further includes a display for displaying one or more images, notifications, and/or other displayable data. In some aspects, the apparatuses described above can include one or more sensors (e.g., one or more inertial measurement units (IMUs), such as one or more gyroscopes, one or more gyrometers, one or more accelerometers, any combination thereof, and/or other sensor).

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and aspects, will become more apparent upon referring to the following specification, claims, and accompanying drawings.

### BRIEF DESCRIPTION OF THE DRAWINGS

Illustrative aspects of the present application are described in detail below with reference to the following drawing figures:

FIG. 1 is a block diagram illustrating a process for auto-regressive decoding using an auto-regressive transformer model across N iterations, with inference graph topology and respective sizes of input tokens and intermediate activations changing dynamically with each iteration, in accordance with some examples;

FIG. 2 is a block diagram illustrating a process for auto-regressive decoding using an auto-regressive transformer model across T iterations, with a key framer for caching key features and a value framer for caching value features, allowing inference graph topology and respective sizes of input tokens and intermediate activations to remain static with each iteration, in accordance with some examples;

FIG. 3 is a conceptual diagram illustrating a framer for caching features (e.g., key features or value features) from different iterations of a decoding process in a buffer, in accordance with some examples;

FIG. 4 is a block diagram illustrating an example of a system with an encoder and decoder that can be used to process an input to generate an output, in accordance with some examples;

FIG. 5 is a block diagram illustrating an example of a neural network that can be used for imaging, in accordance with some examples;

FIG. 6 is a flow diagram illustrating a process for decoding, in accordance with some examples; and

FIG. 7 is a diagram illustrating an example of a computing system for implementing certain aspects described herein.

### DETAILED DESCRIPTION

Certain aspects of this disclosure are provided below. Some of these aspects may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the spirit and scope of the application as set forth in the appended claims.

Machine learning models are useful for a variety of tasks, including image processing, computer vision, natural language processing, and generating content. In some examples, a machine learning model can process data across multiple iterations, with each iteration dependent upon at least one previous iteration. For instance, in some examples, an auto-regressive transformer model can generate tokens one at a time sequentially across iterations, with later tokens from later iterations generated based (at least in part) on previously generated tokens from previous iterations. In some cases, processing data across multiple iterations in a machine learning model in this way can cause inefficiencies, such as duplicated computation(s) between iterations. In some cases, processing data across multiple iterations in a machine learning model in this way can further cause the sizes of input(s) and/or intermediate activation(s) to grow from earlier iterations to later iterations, which can cause changes to the inference graph and computations (e.g., attention computation(s)) performed using the tokens and intermediate activation(s). In some cases, the dynamic nature of the computation and memory usage limits the optimizations that can be applied on the computation graph. Furthermore, the dynamic nature of the inference graph and associated computations in such machine learning models can prevent such machine learning models from being compatible with certain artificial intelligence (AI) accelerator frameworks that rely on static inference graphs, which can reduce compatibility with certain devices, and which can force such machine learning models to be run in less efficient ways.

Systems and techniques for cached decoding are described. A system (e.g., decoder) receives an input token (e.g., input vector). The system applies a projection tensor (e.g., a projection matrix) to the input token to generate a feature tensor (e.g., a key tensor or a value tensor). The system processes at least the feature tensor and at least one previous feature tensor using at least one attention calculation to generate an output token. The at least one previous feature tensor is retrieved from a buffer. In some examples, the at least one previous feature tensor can be stored in the buffer after having been previously calculated based on application of the projection tensor to a previous input token (e.g., from a previous iteration before the iteration in which the input token is received). By retrieving the at least one previous feature tensor that was cached in the buffer, the system can avoid duplicated computations to increase efficiency, make aspects of the computation graph more static to enable further optimizations to the computation graph, improve compatibility with AI accelerator frameworks that rely on static inference graphs, and take advantage of improvements to efficiency from use of those AI accelerator frameworks, or combinations thereof.

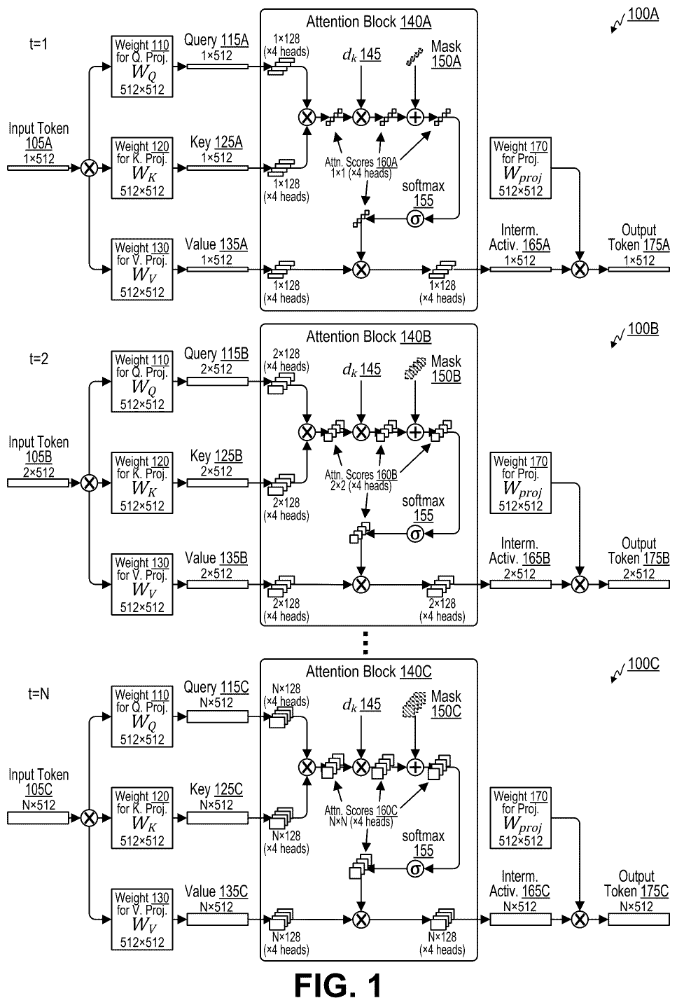

Various aspects of the application will be described with respect to the figures. FIG. 1 is a block diagram illustrating a process for auto-regressive decoding using an auto-regressive transformer model across N iterations, with inference graph topology and respective sizes of input tokens and intermediate activations changing dynamically with each iteration. In the example of FIG. 1, three iterations along the process are illustrated, with an iteration counter variable t representing the iteration number illustrated. A first iteration 100A is illustrated where t=1. A second iteration 100B is illustrated where t=2. An Nth iteration 100C is illustrated where t=N.

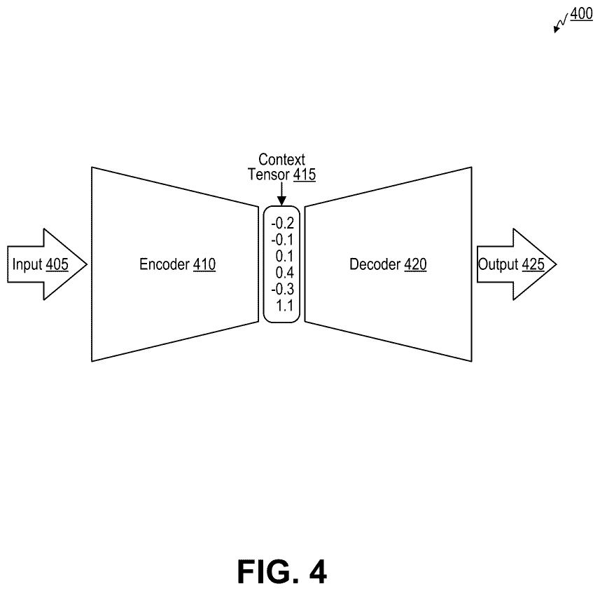

In the first iteration 100A, the iteration counter indicates that t=1, and an input token 105A is input into the auto-regressive transformer model. In the example illustrated in FIG. 1, the input token 105A is a tensor (e.g., a vector) having dimensions 1×512. Because the auto-regressive transformer model is part of a decoder (e.g., decoder 420 in FIG. 4), the input token 105A may be part of, and/or may be based on, a context tensor (e.g., context tensor 415 in FIG. 4) output by an encoder (e.g., encoder 410 in FIG. 4). In some examples, the input token 105A in the first iteration 100A is a start-of-sentence token, also referred to as a beginning-of-sentence token, a start token, a beginning token, or a combination thereof.

A set of projection tensors (e.g., projection matrices) are applied to the input token 105A using matrix multiplication and/or tensor multiplication and/or dot products. The projection tensors include a weight tensor W_{Q} 110 for query projection, a weight tensor W_{K} 120 for key projection, and a weight tensor W_{V} 130 for value projection. Applying the weight tensor W_{Q} 110 for query projection to the input token 105A (e.g., using matrix multiplication and/or dot product multiplication) generates a query 115A, which is a tensor (e.g., vector) and/or feature having dimensions 1×512 in the example of FIG. 1. Applying the weight tensor W_{K} 120 for key projection to the input token 105A (e.g., using matrix multiplication and/or dot product multiplication) generates a key 125A, which is a tensor (e.g., vector) and/or feature having dimensions 1×512 in the example of FIG. 1. Applying the weight tensor W_{V} 130 for value projection to the input token 105A (e.g., using matrix multiplication and/or dot product multiplication) generates a value 135A, which is a tensor (e.g., vector) and/or feature having dimensions 1×512 in the example of FIG. 1.

In some examples, weight tensor W_{Q} 110 for query projection, the weight tensor W_{K} 120 for key projection, and/or the weight tensor W_{V} 130 for value projection are generated during training of the auto-regressive transformer model. In some examples, the auto-regressive transformer model is trained to generate these weight tensors to reduce dimensionality of the query 115A, key 125A, and value 135A tensors. In some examples, the auto-regressive transformer model is trained to generate these weight tensors to representing the relative importance of the inputs in a sequence (e.g., keys including the key 125A) for a particular output (e.g., queries including the query 115A). Multiplying the weights with the input sequence (e.g., values including the value 135A) will then weight the sequence.

The auto-regressive transformer model includes an attention block 140A that processes the query 115A, key 125A, and value 135A tensors through concatenation, matrix multiplications, linear transformations, scaling, masking, and/or normalization. For instance, the attention block 140A multiplies concatenated tensors that are based on the query 115A and the key 125A (e.g., using matrix multiplication and/or dot product multiplication) to generate a product. The concatenated tensors can have 4 heads with dimensions 1×128 each. The attention block 140A scales the product using a scaling factor dₖ 145, for instance by dividing the product by \sqrt{dₖ}. In some examples, the query 115A, the key 125A, and/or the value 135A tensors are dₖ-dimensional vectors whose components are variables with a mean of 0 and a variance of 1. In some examples, the product of the query 115A and the key 125A can have a mean of 0 and a variance equivalent to the scaling factor dₖ 145. Scaling the product of the query 115A and the key 125A using the scaling factor dₖ 145 (e.g., dividing the product by \sqrt{dₖ}) can keep the mean of the product at 0 and bring the variance of the product to 1.

In some examples, the attention block 140A of the auto-regressive transformer model includes a mask 150A. The mask 150A can be added (e.g., using an adder) to the product of the query 115A and the key 125A (e.g., after the scaling discussed above) to confine the attention span to only valid portion(s) of data (e.g., to remove portion(s) of the product or scaled product associated with invalid data). The attention block 140A of the auto-regressive transformer model includes a softmax function σ 155 that can normalize the product (e.g., the scaled and/or masked product). The attention block 140A of the auto-regressive transformer model multiplies a concatenated variant of the value 135A (e.g., concatenated tensors having 4 heads with dimensions 1×128 each) with the scaled, masked, and/or normalized product (e.g., using matrix multiplication and/or dot product multiplication) to generate tensor(s) (e.g., having 4 heads with dimensions 1×128 each) that can be combined into an intermediate activation tensor 165A with dimensions 1×512. In some examples, the various tensors produced in the attention block 140A can be referred to as attention scores 160A and/or intermediate activations and can have 4 heads with dimensions 1×1 each, as does the mask 150A. In some examples, the auto-regressive transformer model applies a weight tensor Wₚᵣₒⱼ 170 for projection to the intermediate activation tensor 165A (e.g., using matrix multiplication and/or dot product multiplication) to generate an output token 175A with dimensions 1×512. In some examples, the output token 175A can represent a predicted token, for instance a predicted next word, set of one or more characters, phrase, or the like.

In the second iteration 100B, the iteration counter indicates that t=2, and an input token 105B is input into the auto-regressive transformer model. In the example illustrated in FIG. 1, the input token 105B is a tensor (e.g., a vector) having dimensions 2×512. In some examples, the input token 105B has dimensions 2×512 because the input token 105B includes the input token 105A (e.g., a start of sentence token) and the output token 175A from the first iteration 100A. This way, the second iteration 100B includes all of the context up to this point. Because each of these have dimensions 1×512, the dimensions of the input token 105B are 2×512. Because the dimensions of the input token 105B are 2×512, the dimensions of query 115B, key 125B, and value 135B are also 2×512. Similarly, attention scores 160B have 4 heads with dimensions 2×2 each, as does mask 150B. Attention block 140B outputs an intermediate activation tensor 165B with dimensions 2×512. The auto-regressive transformer model applies the weight tensor Wₚᵣₒⱼ 170 for projection to the intermediate activation tensor 165B (e.g., using matrix multiplication and/or dot product multiplication) to generate an output token 175B with dimensions 2×512. The output token 175B can represent a predicted token, for instance a predicted next word, set of one or more characters, phrase, or the like.

In the N^{th} iteration 100C, the iteration counter indicates that t=N, and an input token 105C is input into the auto-regressive transformer model. In the example illustrated in FIG. 1, the input token 105C is a tensor (e.g., a vector) having dimensions N×512. In some examples, the input token 105C has dimensions N×512 because the input token 105C includes the input token 105A (e.g., a start of sentence token), the output token 175A from the first iteration 100A, the output token 175B from the second iteration 100B, and/or any other output tokens of any iterations in between the second iteration 100B and the N^{th} iteration 100C (e.g., a third iteration where t=3, a fourth iteration where t=4, and so forth). This way, the N^{th} iteration 100C includes all of the context up to this point. Because of this, the dimensions of the input token 105C are N×512. Because the dimensions of the input token 105C are N×512, the dimensions of query 115N, key 125N, and value 135N are also N×512. Similarly, attention scores 160C have 4 heads with dimensions N×N each, as does mask 150N. Attention block 140C outputs an intermediate activation tensor 165C with dimensions N×512. The auto-regressive transformer model applies the weight tensor Wₚᵣₒⱼ 170 for projection to the intermediate activation tensor 165C (e.g., using matrix multiplication and/or dot product multiplication) to generate an output token 175C with dimensions N×512. The output token 175C can represent a predicted token, for instance a predicted next word, set of one or more characters, phrase, or the like. In some cases, the output token 175C can represent an end of sentence or another type of end token.

As illustrated in FIG. 1 and described above, the auto-regressive transformer model of FIG. 1 functions in a way that causes each successive input token 105A-105N to grow in size with each iteration from the first iteration 100A to the Nth iteration 100C. Likewise, intermediate activations such as the attention scores 160A-160C and outputs such as the output tokens 175A-175C also grow in size with each iteration from the first iteration 100A to the Nth iteration 100C. This causes each attention block calculation 140A-140C from the first iteration 100A to the Nth iteration 100C to be different from the previous iteration, and to be more computationally expensive than the previous iteration. In some cases, the dynamic nature of the computation and memory usage limits the optimizations that can be applied on the computation graph (e.g., for the attention scores 160A-160C and/or other portions of the auto-regressive transformer model). Furthermore, the dynamic nature of the inference graph and associated computations in such machine learning models can prevent such machine learning models from being compatible with certain artificial intelligence (AI) accelerator frameworks rely on static inference graphs, which can reduce compatibility with certain devices, and which can force such machine learning models to be run in less efficient ways.

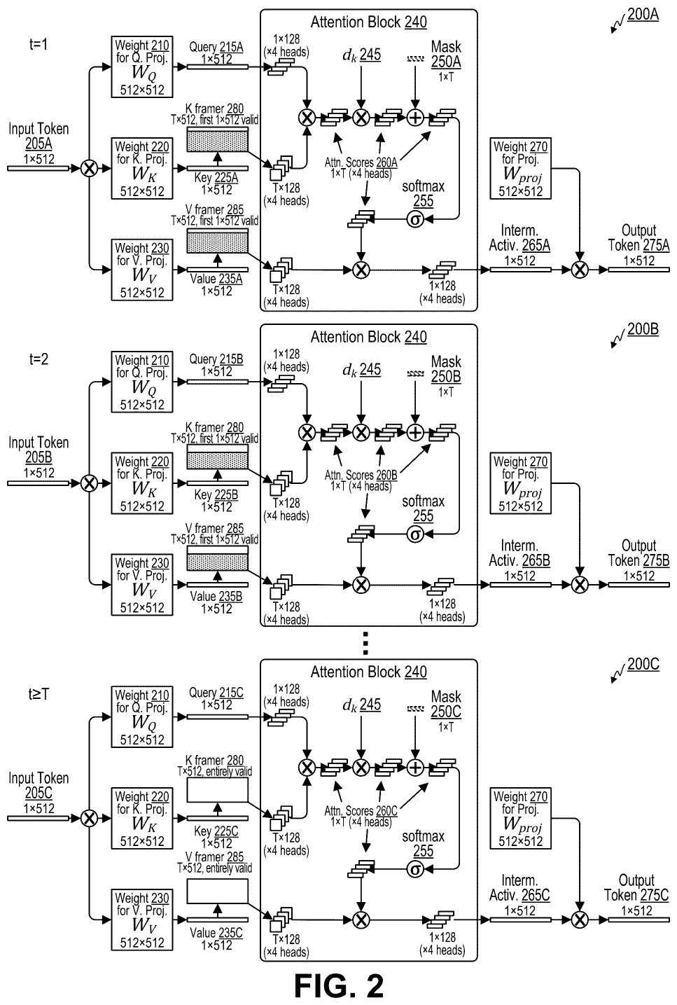

FIG. 2 is a block diagram illustrating a process for auto-regressive decoding using an auto-regressive transformer model across T iterations, with a key framer 280 for caching key features and a value framer 285 for caching value features, allowing inference graph topology and respective sizes of input tokens and intermediate activations to remain static with each iteration. Three iterations along the process are illustrated, with an iteration counter variable t representing the iteration number illustrated. A first iteration 200A is illustrated where t=1. A second iteration 200B is illustrated where t=2. An iteration 200C is illustrated where t=T.

In the first iteration 200A, the iteration counter indicates that t=1, and an input token 205A is input into the auto-regressive transformer model. In the example illustrated in FIG. 2, the input token 205A is a tensor (e.g., a vector) having dimensions 1×512. The input token 205A may be the equivalent to the input token 105A. Because the auto-regressive transformer model is part of a decoder (e.g., decoder 420 in FIG. 4), the input token 205A may be part of, and/or may be based on, a context tensor (e.g., context tensor 415 in FIG. 4) output by an encoder (e.g., encoder 410 in FIG. 4). In some examples, the input token 205A in the first iteration 200A is a start-of-sentence token.

Applying the weight tensor W_{Q} 210 for query projection (trained similarly to the weight tensor W_{Q} 110 for query projection in FIG. 1) to the input token 205A (e.g., using matrix multiplication and/or dot product multiplication) generates a query 215A, which is a tensor (e.g., vector) and/or feature having dimensions 1×512 in the example of FIG. 2. Applying the weight tensor W_{K} 220 for key projection (trained similarly to the weight tensor W_{K} 120 for key projection in FIG. 1) to the input token 205A (e.g., using matrix multiplication and/or dot product multiplication) generates a key 225A, which is a tensor (e.g., vector) and/or feature having dimensions 1×512 in the example of FIG. 2. Applying the weight tensor W_{V} 230 for value projection (trained similarly to the weight tensor W_{V} 130 for value projection in FIG. 1) to the input token 205A (e.g., using matrix multiplication and/or dot product multiplication) generates a value 335A, which is a tensor (e.g., vector) and/or feature having dimensions 1×512 in the example of FIG. 2.

The key framer 280 is a subsystem (e.g., a stateful buffer manager) that controls and/or manages a key buffer. During the first iteration 200A, the key framer 280 stores (caches) the key 225A. In some cases, the key buffer can have dimensions T×512. The key buffer can be filled with invalid data (e.g., values of zero, negative infinity, infinity, “undefined,” or another specified value indicative of invalid data) before valid data is added to the key buffer. The key framer 280 can overwrite a portion of the invalid data in the key buffer (e.g., a row, such as the top row as illustrated in FIG. 2) with the key 225A.

Similarly, the value framer 285 is a subsystem (e.g., a stateful buffer manager) that controls and/or manages a value buffer. During the first iteration 200A, the value framer 285 stores (caches) the value 235A. In some cases, the value buffer can have dimensions T×512. The value buffer can be filled with invalid data (e.g., values of zero, negative infinity, infinity, “undefined,” or another specified value indicative of invalid data) before valid data is added to the value buffer. The value framer 285 can overwrite a portion of the invalid data in the value buffer (e.g., a row, such as the top row as illustrated in FIG. 2) with the value 235A.

In some examples, attention block 240 can use the key 225A as retrieved from the key buffer using the key framer 280. In some examples, attention block 240 can use the value 235A as retrieved from the value buffer using the value framer 285. The key buffer and can have dimensions T×512 to cache key tensors calculated in each iteration t for up to T iterations. Similarly, the value buffer and can have dimensions T×512 to cache value tensors calculated in each iteration t for up to T iterations. In some examples, the key framer 280 and/or the value framer 285 can maintain counter(s) indicating how many tensors have been cached in the key buffer and value buffer, respectively. The iteration counter t in FIG. 2 can represent such a counter in the key framer 280 and/or the value framer 285. Invalid data in the key buffer and value buffer is illustrated in FIG. 2 as shaded with a halftone pattern. Valid data in the key buffer and value buffer is illustrated in FIG. 2 as white without any halftone pattern shading.

The attention block 240 of FIG. 2 is similar to the attention blocks 140A-140C of FIG. 1 but is static across all iterations 200A-200C thanks to use of the key framer 280 and value framer 285. As noted above, in the first iteration 200A, the key framer 280 stores the key 225A in the key buffer, and the value framer 285 stores the value 235A in the value buffer. In some examples, in the first iteration 200A, the attention block 240 can receive the query 215A, key 225A, and value 235A directly following application of the projection tensors (e.g., the weight tensor W_{Q} 210 for query projection, the weight tensor W_{K} 220 for key projection, and the weight tensor W_{V} 230 for value projection) to the input token 205A. In some examples, in the first iteration 200A, the attention block 240 can receive the query 215A following application of the weight tensor W_{Q} 210 for query projection to the input token 205A, but the attention block 204 can receive the key 225A from the key framer 280 (and/or from its key buffer) and/or receive the value 235A from the value framer 285 (and/or from its value buffer).

In some examples, for each of the iterations 200A-200C, the key framer 280 can pass the entire key buffer to the attention block 240 for the attention computation, and the value framer 285 can pass the entire value buffer to the attention block 240 for the attention computation. In some examples, for each of the iterations 200A-200C, the key framer 280 can maintain the entire key buffer until the next iteration (where the key framer 280 can append another key), and the value framer 285 can maintain the entire value buffer until the next iteration (where the value framer 285 can append another value).

The attention block 240 can process the query 215A, the key 225A, and the value 235A to generate attention scores 260A and eventually intermediate activation tensor 265A and output token 275A. The attention scores 260A can include a product of the query 215A with the key 225A (e.g., or a concatenated variant thereof), scaled according to the scaling factor dₖ 245, masked according to mask 250B, normalized using softmax function σ 255, and/or multiplied with the values (or concatenated variants thereof). The auto-regressive transformer model applies a weight tensor Wₚᵣₒⱼ 270 for projection to the intermediate activation tensor 265A (e.g., using matrix multiplication and/or dot product multiplication) to generate the output token 275A.

In the second iteration 200B, the key framer 280 appends key 225B (e.g., generated by applying the weight tensor W_{K} 220 for key projection to the input token 205B) into the key buffer (that already includes the key 225A). Similarly, in the second iteration 200B, the value framer 285 appends the value 235B (e.g., generated by applying the weight tensor W_{V} 230 for value projection to the input token 205B) into the value buffer (that already includes the value 235A). The attention block 240 can receive the key 225A and the key 225B from the key framer 280 (which retrieves these from the key buffer). The attention block 240 can receive the value 235A and the value 235B from the value framer 285 (which retrieves these from the value buffer). The attention block 240 can process these keys and values with the query 215B to generate attention scores 260B and eventually intermediate activation tensor 265B and output token 275B. The attention scores 260B can include a product of the query 215B with the keys (e.g., or concatenated variants thereof), scaled according to the scaling factor dₖ 245, masked according to the mask 250B, normalized using the softmax function σ 255, and/or multiplied with the values (or concatenated variants thereof). The auto-regressive transformer model applies a weight tensor Wₚᵣₒⱼ 270 for projection to the intermediate activation tensor 265B (e.g., using matrix multiplication and/or dot product multiplication) to generate the output token 275B.

In the iteration 200C (where the iteration counter t is greater than or equal to T), the key framer 280 appends the key 225C (e.g., generated by applying the weight tensor W_{K} 220 for key projection to the input token 205C) into the key buffer. The key buffer can already include the key 225A, the key 225B, and/or various other keys for iterations between 2 and the iteration number t. In some examples, if t is greater than T (t>T), and the key buffer only has T rows, the key framer 280 can discard the oldest key (or least important key according to importance metric(s)) in the key buffer, for instance overwriting the key 225C over the oldest key (or least important key according to importance metric(s)), or shifting the keys in the key buffer up by one row to make space at the bottom of the key buffer for the key 225C.

Similarly, in the iteration 200C, the value framer 285 appends the value 235C (e.g., generated by applying the weight tensor W_{V} 230 for value projection to the input token 205C) into the value buffer (that already includes the value 235A). The value buffer can already include the value 235A, the value 235B, and/or various other values for iterations between 2 and the iteration number t. In some examples, if t is greater than T (t>T), and the value buffer only has T rows, the value framer 285 can discard the oldest value (or least important value according to importance metric(s)) in the value buffer, for instance overwriting the value 235C over the oldest value (or least important value according to importance metric(s)), or shifting the values in the value buffer up by one row to make space at the bottom of the value buffer for the value 235C.

In some examples, an importance metric can be stored (e.g., by the key framer 280 and/or the value framer 285) for each of the keys and/or values that are stored in the buffers (e.g., the key buffer corresponding to the key framer 280 and/or the value buffer corresponding to the value framer 285). In some examples, the importance metrics for the keys can be determined by the key framer 280 and/or stored by the key framer 280 in the key buffer. In some examples, the importance metrics for the values can be determined by the value framer 285 and/or stored by the value framer 285 in the value buffer. The importance metric can be used (e.g., by the key framer 280 and/or the value framer 285) to determine which keys and/or values to discard if t is greater than T (t>T).

For instance, in some examples, rather than discarding the oldest key or oldest value in the buffer, the key framer 280 and/or the value framer 285 can discard the least important key or least important value in the buffer, to make space for the new key (e.g., key 225C) or new value (e.g., value 235C) in the buffer. In some examples, the importance metric of a key or value can be based on a confidence determination associated with the key or value, a degree to which the key or value influences output token(s) (e.g., any of output tokens 275A-275C) generated based on the key buffer and/or value buffer (e.g., relative to other keys and/or values and/or queries), a level of similarity or level of difference of the key or value compared to other keys or values stored in the buffer, or a combination thereof.

In some examples, several different keys or values can be assigned equivalent importance metrics. For instance, if an importance metric can be set to one of three possible settings for each key or value (e.g., representing low importance, medium importance, or high importance, respectively), and the buffer has space for 10 rows (e.g., 10 keys or 10 values), then multiple keys or values will be assigned equivalent importance metrics. In such situations, the key framer 280 or value framer 285 can discard the oldest key or value of the set of keys or values that have the lowest importance metric in the buffer. In some examples, the number of possible settings for the importance metric is equivalent to the number of keys or values that can be stored in the buffer (e.g., T in FIG. 2), so that each key or value can have an importance metric that is unique from those of the other keys or values in the buffer, allowing the importance metrics to behave as an ordered ranking of keys or values. The importance metric can be referred to as an importance metric, ranking metric, a prioritization metric, a priority metric, a significance metric, an order metric, a weight metric, an importance indicator, ranking indicator, a prioritization indicator, a priority indicator, a significance indicator, an order indicator, a weight indicator, or a combination thereof.

The attention block 240 can receive the key 225C and older keys (e.g., the key 225 and/or the key 225B) from the key framer 280 (which retrieves these from the key buffer). The attention block 240 can receive the value 235C and old values (e.g., the value 235A and/or the value 235B) from the value framer 285 (which retrieves these from the value buffer). The attention block 240 can process these keys and values with the query 215C to generate the attention scores 260C and eventually the intermediate activation tensor 265C and the output token 275C. The attention scores 260C can include a product of the query 215C with the keys (e.g., or concatenated variants thereof), scaled according to the scaling factor dₖ 245, masked according to the mask 250C, normalized using the softmax function σ 255, and/or multiplied with the values (or concatenated variants thereof). The auto-regressive transformer model applies a weight tensor Wₚᵣₒⱼ 270 for projection to the intermediate activation tensor 265C (e.g., using matrix multiplication and/or dot product multiplication) to generate the output token 275C. In some examples, the input token 205C represents an end of sentence token, also referred to as an end token.

The calculations to generate the queries 215A-215C, keys 225A-225C, and values 235A-235C are represented below in Equation 1 through Equation 3:

$$q = {W}_{Q} x \qquad Equation 1$$

$$K = {W}_{K} x \qquad Equation 2$$

$$V = {W}_{V} x \qquad Equation 3$$

The calculations in the attention block 240 are represented below in Equation 4:

$$attn ( q , K , V ) = softmax ( \frac{q {K}^{T}}{\sqrt{{d}_{k}}} ) V \qquad Equation 4$$

In Equation 1 through Equation 4, x represents an input token (e.g., one of the input tokens 205A-205C), q represents a query (e.g., one of the queries 215A-215C), W_{Q} represents the weight tensor W_{Q} 210 for query projection, K represents a key (e.g., one of the keys 225A-225C), W_{K} represents the weight tensor W_{K} 220 for key projection, V represents a value (e.g., one of the values 235A-235C), W_{V} represents the weight tensor W_{V} 230 for value projection, the attn( ) function represents the attention block 240, dₖ represents the scaling factor dₖ 245, the softmax( ) function represents the softmax function σ 255, T represents the number of rows in the key buffer (e.g., corresponding to the key framer 280) and the value buffer (e.g., corresponding to the value framer 285) (and thus the numbers of key that can be stored in the key buffer and the numbers of values that can be stored in the value buffer).

In an illustrative example, at an iteration 1 (e.g., t=1), the embedding of an initial input token 205A (e.g., start of sentence token <SOT>) goes through the query, key, and value projections to generate the query 215A, key 225A, and value 235A. The key 225A is input by the key framer 280 to the key buffer, for instance stored in the first row (e.g., top row) of the key buffer. The value 235A is input by the value framer 285 to the value buffer, for instance stored in the first row (e.g., top row) of the value buffer. At that moment, only the first rows of the key buffer and the value buffer include valid data, with the rest of the rows representing invalid data (e.g., zero, negative infinity, infinity, “undefined,” or another specified value indicative of invalid data). Each framer (e.g., of the key framer 280 and the value framer 285) outputs its entire buffer (with T rows) to the next node in the attention block 240 for the attention score calculation (qK^{T}). To consider only the valid portion of the attention score, the mask 250A (e.g., with shape 1×T), which is iteration dependent, is set to 0 (or another specified value representing valid data) for the first element and negative infinity (or another specified value representing invalid data) for the rest of the elements, so that only the first element of the attention score takes effect in the softmax function σ 255 and thus the multiplication with the output of the value framer 285A.

Continuing the illustrative example, at iteration 2 (e.g., t=2), the output(s) of the first iteration (e.g., the output token 175A) can be the input token 105B. Similarly to the first iteration, the corresponding key 225B and value 235B are cached in the second row of key buffer (by key framer 280) and the value buffer (by the value framer 285) respectively. The mask 250B is set to 0 (or another specified value representing valid data) for the first two elements and negative infinity (or another specified value representing invalid data) for the rest of the elements. The mask 250B ensures that the softmax function σ 255 is confined to only the first two elements. Similarly, for an iteration t in an iteration in which t is greater than or equal to T (t≥T), the output(s) of the previous iteration (e.g., an output token from an iteration t−1, not shown in FIG. 2) is the input token 105C. The corresponding key 225C and value 235C can be cached in the t^{th} row of the key buffer (by key framer 280) and in the t^{th} row of the value buffer (by the value framer 285) respectively. In some examples, the first t elements of any iteration-dependent mask (e.g., of the masks 250A-250C) are set to 0 and negative infinity for the rest of the elements to confine the softmax calculation (e.g., using the softmax function σ 255) to only the first t elements. The key framer 280 and value framer 285 only keep the latest T (maximum context length) tensors in the key buffer and value buffer, respectively. Once the iteration t is larger than T (t>T), the oldest key or value, or least important key or value (e.g., according to importance metric(s)), is discarded to make space for the incoming current key 225C or value 235C. Starting from the T^{th} iteration, all the elements in the mask (e.g., mask 250C) are set to 0 (or another specified value representing valid data) and thus all the elements in each buffer (e.g.) are valid and are to be used for softmax computation (e.g., using the softmax function σ 255).

The use of the key framer 280 and value framer 285 in the auto-regressive transformer model architecture of FIG. 2 allows the auto-regressive transformer model of FIG. 2 to avoid duplicated computations relative to the auto-regressive transformer model of FIG. 1, thereby providing improved efficiency to the auto-regressive transformer model of FIG. 2 relative to the auto-regressive transformer model of FIG. 1. For instance, in the second iteration 200B, the auto-regressive transformer model of FIG. 2 does not need to include the input token 205A in the input token 205B (allowing the input token 205B to maintain dimensions of 1×512 rather than increasing to 2×512 as in the input token 105B in FIG. 1). The auto-regressive transformer model does not need to re-compute the key 225A and value 235A, since the key 225A and value 235A are retrieved by the key framer 280 from the key buffer and by the value framer 285 from the value buffer, respectively. This improvement to efficiency grows as the number of iterations increases, as in the iteration 200C where the iteration number t is greater than or equal to T (t≥T), the auto-regressive transformer model of FIG. 2 does not need to include any previous input tokens (e.g., the input token 205A and/or the input token 205B) in the input token 205C (allowing the input token 205C to maintain dimensions of 1×512 rather than increasing to t×512 similarly to the input token 105C), and the auto-regressive transformer model does not need to re-compute previous keys or values (e.g., key 225A, key 225B, value 235A, and/or value 235B), since the previous keys and values are retrieved by the key framer 280 from the key buffer and by the value framer 285 from the value buffer, respectively. Keeping these dimensions small reduces total memory usage and bandwidth usage of connections within computing system(s) running the auto-regressive transformer model.

The use of the key framer 280 and value framer 285 also allows the computation graph for the attention block 240, and for the auto-regressive transformer model of FIG. 2 more generally, more static, with unchanging dimensions for input tokens 205A-205C, queries 215A-215C, keys 225A-225C, values 235A-235C, attention scores 260A-260C, masks 250A-250C, intermediate activations 265A-265C, and output tokens 275A-275C. The static nature of the computation graph for the attention block 240 and auto-regressive transformer model of FIG. 2 reduces graph complexity allows for further optimizations to the computation graph (e.g., relative to the attention blocks 140A-140C that are dynamic and the auto-regressive transformer model of FIG. 1), for instance reduces total memory usage and bandwidth usage. The static nature of the computation graph for the attention block 240 and auto-regressive transformer model of FIG. 2 also makes the auto-regressive transformer model of FIG. 2 more compatible with a number of AI accelerator frameworks that provide hardware and software optimizations to efficiency compared to other processing systems that are not optimized for running such models. Examples of such AI accelerator frameworks can include a neural signal processor (NSP), an embedded neural processing unit (eNPU), or Qualcomm® Cloud AI 100, and/or Qualcomm® Qranium® SDK. The static nature of the computation graph for the attention block 240 and auto-regressive transformer model of FIG. 2 also makes the auto-regressive transformer model of FIG. 2 more compatible with various models and applications that use transformer decoder architecture, such as transformer-based neural machine translation (NMT), OpenAI® Whisper® models, OpenAIR ChatGPT®, large language models (LLMs), or a combination thereof, and can improve efficiency of inference for those models.

In some examples, the mask (e.g., masks 250A-250C) can have dimensions 1×T. In some examples, the mask (e.g., masks 250A-250C) can be iteration dependent, for instance confining the attention span of the attention block 240 to focus on valid keys from the key buffer (and/or ignore invalid keys from the key buffer) and/or to focus on valid values from the values buffer (and/or ignore invalid values from the values buffer). For instance, in the first iteration 200A, only the portion(s) of the key buffer caching the key 225A (e.g., the top row of the key buffer) and the portion(s) of the value buffer caching the value 235A (e.g., the top row of the value buffer) are valid, with the rest of the key buffer and the rest of the value buffer being invalid and, in some examples, masked out using the mask 250A. Similarly, in the second iteration 200B, only the portion(s) of the key buffer caching the keys 225A-225B (e.g., the top two rows of the key buffer) and the portion(s) of the value buffer caching the values 235A-235B (e.g., the top two rows of the value buffer) are valid, with the rest of the key buffer and the rest of the value buffer being invalid and, in some examples, masked out using the mask 250B. In the iteration 200C, the entirety of the key buffer caches valid keys and the entirety of the value buffer caches valid values, so in some examples, the mask 250C can mask little or nothing.

In some examples, the masks 250A-250C can be used to weight more recent keys and/or values more heavily than older keys and/or values. In some examples, the masks 250A-250C can be used to weight more important keys and/or values (e.g., more recent keys or values, and/or keys or values having higher importance metrics) more heavily than less important keys and/or values, so that the more important keys and/or values have a larger influence on the corresponding output token (e.g., of the output tokens 275A-275C) than the less important keys and/or values do.

In some examples, while the key framer 280 and value framer 285 are illustrated as separate subsystems or components, the auto-regressive transformer model of FIG. 2 can instead use a single framer subsystem or component that manages adding and retrieving keys and values to and from both the key buffer and the value buffer. In some examples, while the key buffer and value buffer are illustrated as separate buffers each having with dimensions T×512, the auto-regressive transformer model of FIG. 2 can instead use a single buffer for caching both keys (e.g., keys 225A-225C) and values (e.g., values 235A-235C), for instance having dimensions 2T×512. In an illustrative example, such a combined buffer can store the keys in one half of the buffer and the values in the other half of the buffer. In a second illustrative example, such a combined buffer can store the keys interleaved, so that a key is followed by a value, and a value is followed by a key, and so forth.

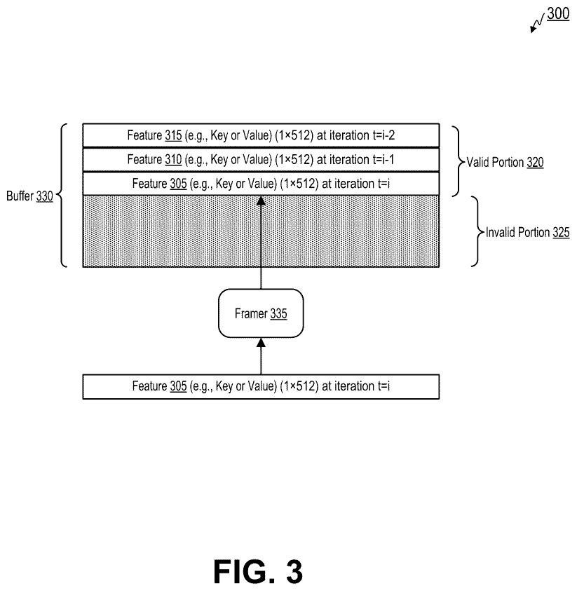

FIG. 3 is a conceptual diagram 300 illustrating a framer 335 for caching feature tensors 305-315 (e.g., keys or values) from different iterations of a decoding process in a buffer 330. A feature tensor 305 is illustrated as a tensor having dimensions 1×512, for instance representing one of the keys 225A-225C or one of the values 235A-235C generated as discussed with respect to one of the iterations 200A-200C in FIG. 2. In the context of FIG. 3, the iteration that the feature tensor 305 is generated in is identified as t=i. The framer 335 is an example of the key framer 280 and/or the value framer 285 in FIG. 2. The framer 335 receives the feature tensor 305 and appends the feature tensor 305 to the existing valid data in the buffer 330, which includes two previous features-a feature tensor 310 from iteration t=i−1 and a feature tensor 315 from iteration t=i−2. Once the framer 335 appends the feature tensor 305 into the valid data in the buffer 330, the resulting valid portion 320 of the buffer 330 includes the feature tensor 305, the feature tensor 310, and the feature tensor 315, organized in ascending temporal order of iterations from the top of the buffer 330 down. The buffer 330 includes an invalid portion 325 that is still to be filled in by the framer 335 with future feature(s) from future iterations. The invalid portion 325 of the buffer 330 is illustrated in FIG. 3 as shaded with a halftone pattern. In various aspects, the buffer 330 is equal to a sum and/or a combination of the valid portion 320 and the invalid portion 325. In other aspects, the buffer 330 is greater than a sum and/or a combination of the valid portion 320 and the invalid portion 325. The feature tensors 305-315 can be referred to as features.

FIG. 4 is a block diagram illustrating an example of a system 400 with an encoder 410 and decoder 420 that can be used to process an input 405 to generate an output 425. The auto-regressive transformer models of FIGS. 1 and 2 are examples of the decoder 420. In some examples, the auto-regressive transformer models of FIG. 2 are more efficient than the auto-regressive transformer models of FIG. 1 as discussed herein. In some examples, an auto-regressive transformer model can include the encoder 410, the decoder 420, or a combination thereof.

The encoder 410 and decoder 420 can each be at least a portion of, or can each include, at least one machine learning model. The at least one machine learning model can include, for instance, at least one neural network (NN), at least one convolutional neural network (CNN), at least one time delay neural network (TDNN), at least one deep network (DN), at least one autoencoder (AE), at least one variational autoencoder (VAE), at least one deep belief net (DBN), at least one recurrent neural network (RNN), at least one Long Short-Term Memory (LSTM), at least one Gated Recurrent Unit (GRU), at least one generative adversarial network (GAN), at least one conditional generative adversarial network (cGAN), at least one feed-forward network, at least one network having fully connected layers, at least one trained support vector machine (SVM), at least one trained random forest (RF), at least one computer vision (CV) system, at least one autoregressive (AR) model, at least one Sequence-to-Sequence (Seq2Seq) model, at least one large language models (LLM), at least one deep learning system, at least one classifier, at least one transformer, or at least one combination thereof. In examples where the at least one machine learning model includes at least one LLM, the at least one LLM can include, for instance, a Generative Pre-Trained Transformer (GPT) (e.g., GPT-2, GPT-3, GPT-3.5, GPT-4, etc.), DaVinci or a variant thereof, an LLM using Massachusetts Institute of Technology (MIT)® langchain, Pathways Language Model (PaLM), Large Language Model Meta® AI (LLaMA), Language Model for Dialogue Applications (LaMDA), Bidirectional Encoder Representations from Transformers (BERT), Falcon (e.g., 40B, 7B, 1B), Orca, Phi-1, StableLM, variant(s) of any of the previously-listed LLMs, or a combination thereof.

In some examples, the input 405 includes a first string of text, and the output 425 includes a second string of text. In some examples, the output 425 is conversationally responsive to the input 405, for instance as in a chatbot, a virtual assistant, a search engine, or a combination thereof. In some examples, the output 425 is a translation of the input 405 from a first language of the input 405 to a second language of the output 425, as in a neural machine translation (NMT) system. In some examples, the encoder 410 processes the input 405 to generate a context tensor 415, also referred to as a thought tensor, a context vector, a though vector, a context matrix, or a thought matrix. In an illustrative example, the encoder 410 includes an RNN, and the context tensor 415 is the output (e.g., final state) of the RNN. The context tensor 415 is input to the decoder 420. For instance, in some examples, the input tokens 105A-105C (FIG. 1) and/or the input tokens 205A-205C (FIG. 2) can be retrieved from, and/or based on, the context tensor 415 output by the encoder 410. The output 425 can include, and/or be based on, the output tokens 175A-175C (FIG. 1 and/or the output tokens 275A-275C (FIG. 2).

In some examples, the auto-regressive transformer models of FIGS. 1 and 2 can be used for the encoder 410 instead of or in addition to the decoder 420. For instance, in some examples, the input tokens 105A-105C (FIG. 2) and/or the input tokens 205A-205C (FIG. 2) can be retrieved from, and/or based on, the input 405. In such cases, the context tensor 415 can include, and/or be based on, the output tokens 175A-175C (FIG. 1) and/or the output tokens 275A-275C (FIG. 2).

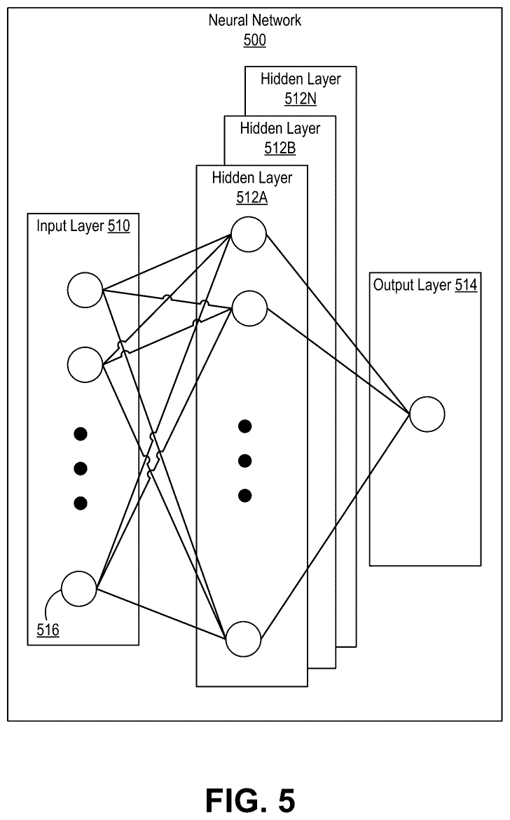

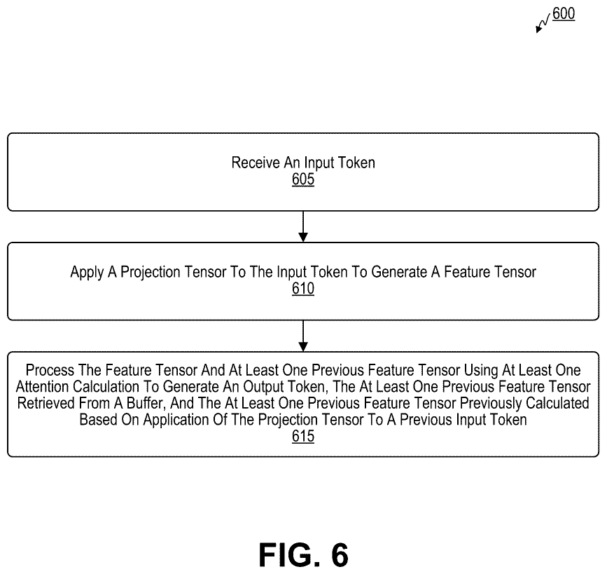

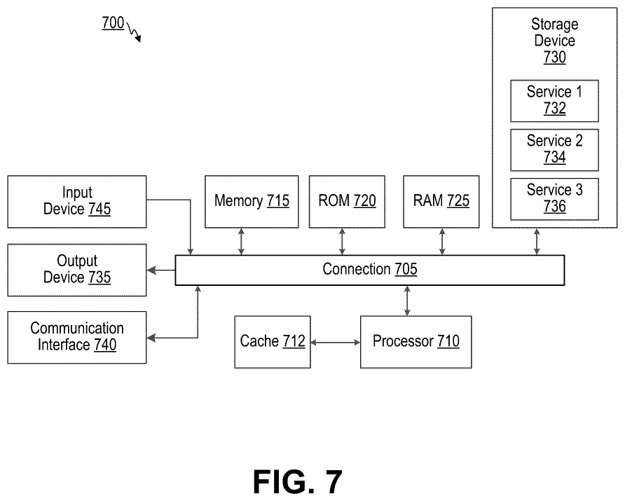

FIG. 5 is a block diagram illustrating an example of a neural network (NN) 500 that can be used for imaging operations. The neural network 500 can include any type of deep network, such as a convolutional neural network (CNN), an autoencoder, a deep belief net (DBN), a Recurrent Neural Network (RNN), a Generative Adversarial Networks (GAN), an auto-regressive transformer models, and/or other type of neural network. With reference to FIGS. 1-7, the neural network 500 may be an example of one of the auto-regressive transformer model of FIG. 1, the auto-regressive transformer model of FIG. 2, the weight tensor W_{Q} 110 for query projection of FIG. 1, the weight tensor W_{K} 120 for key projection of FIG. 1, the weight tensor W_{V} 130 for value projection of FIG. 1, the attention blocks 140A-140C of FIG. 1, the weight tensor Wₚᵣₒⱼ 170 for projection of FIG. 1, the weight tensor W_{Q} 210 for query projection of FIG. 2, the weight tensor W_{K} 220 for key projection of FIG. 2, the weight tensor W_{V} 230 for value projection of FIG. 2, the attention block 240 of FIG. 2, the weight tensor Wₚᵣₒⱼ 270 for projection of FIG. 2, the system 400 of FIG. 4, the encoder 410 of FIG. 4, the decoder 420 of FIG. 4, a machine learning model that performs at least one of the operations 605-516 of the process 600 of FIG. 6, a machine learning model that runs on the computing system 700 of FIG. 7, or a combination thereof.

An input layer 510 of the neural network 500 includes input data. With reference to FIGS. 1-6, the input data of the input layer 510 can include data representing an input token, such as one of the input tokens 105A-105C (FIG. 1) and/or one of the input tokens 205A-205C (FIG. 2). The input data of the input layer 510 can include data from, or based on, the context tensor 415 output by the encoder 410 (FIG. 4). The input data of the input layer 510 can include data from, or based on, the input 405 (FIG. 4). With reference to FIGS. 1-6, in some examples, the input data of the input layer 510 includes at least one input token (e.g., input tokens 105A-150C of FIG. 1, input tokens 205A-205C of FIG. 2, input token of operation 605 of FIG. 6), at least one query (e.g., query 115A-115C of FIG. 1, query 215A-215C of FIG. 2), at least one key (e.g., key 125A-125C of FIG. 1, key 225A-225C of FIG. 2), at least one value (value 135A-135C of FIG. 1, value 235A-235C of FIG. 2), at least one feature (e.g., feature tensors 305-315 of FIG. 3, feature tensor of operation 610 of FIG. 6), data stored in a buffer (e.g., buffer 330 associated with the framer 335 of FIG. 3, key buffer associated with the key framer 280 of FIG. 2, value buffer associated with the value framer 285 of FIG. 2), or a combination thereof. In some examples, the input data of the input layer 510 includes processed data that is to be processed further, such as various features, weights, intermediate data, or a combination thereof.

The neural network 500 includes multiple hidden layers 512, 512B, through 512N. The hidden layers 512, 512B, through 512N include “N” number of hidden layers, where “N” is an integer greater than or equal to one. The number of hidden layers can be made to include as many layers as needed for the given application. The neural network 500 further includes an output layer 514 that provides an output resulting from the processing performed by the hidden layers 512, 512B, through 512N.

In some examples, the output layer 514 can provide output data. With reference to FIGS. 1-6, the output data can include output tokens (e.g., output tokens 175A-175C of FIG. 1, output tokens 275A-275C of FIG. 2, the output token of operation 615 of FIG. 6), at least a portion of a context tensor 415 of FIG. 4, at least a portion of an output 425 of FIG. 4, or a combination thereof. In some examples, a string of text in the output layer 514 is conversationally responsive to a string of text in the input layer 510. In some examples, a string of text in the output layer 514 is a translation of a string of text in the input layer 510 from a first language to a second language.

The neural network 500 is a multi-layer neural network of interconnected filters. Each filter can be trained to learn a feature representative of the input data. Information associated with the filters is shared among the different layers and each layer retains information as information is processed. In some cases, the neural network 500 can include a feed-forward network, in which case there are no feedback connections where outputs of the network are fed back into itself. In some cases, the network 500 can include a recurrent neural network, which can have loops that allow information to be carried across nodes while reading in input.

In some cases, information can be exchanged between the layers through node-to-node interconnections between the various layers. In some cases, the network can include a convolutional neural network, which may not link every node in one layer to every other node in the next layer. In networks where information is exchanged between layers, nodes of the input layer 510 can activate a set of nodes in the first hidden layer 512A. For example, as shown, each of the input nodes of the input layer 510 can be connected to each of the nodes of the first hidden layer 512A. The nodes of a hidden layer can transform the information of each input node by applying activation functions (e.g., filters) to this information. The information derived from the transformation can then be passed to and can activate the nodes of the next hidden layer 512B, which can perform their own designated functions. Example functions include convolutional functions, downscaling, upscaling, data transformation, and/or any other suitable functions. The output of the hidden layer 512B can then activate nodes of the next hidden layer, and so on. The output of the last hidden layer 512N can activate one or more nodes of the output layer 514, which provides a processed output image. In some cases, while nodes (e.g., node 516) in the neural network 500 are shown as having multiple output lines, a node has a single output and all lines shown as being output from a node represent the same output value.

In some cases, each node or interconnection between nodes can have a weight that is a set of parameters derived from the training of the neural network 500. For example, an interconnection between nodes can represent a piece of information learned about the interconnected nodes. The interconnection can have a tunable numeric weight that can be tuned (e.g., based on a training dataset), allowing the neural network 500 to be adaptive to inputs and able to learn as more and more data is processed.

The neural network 500 is pre-trained to process the features from the data in the input layer 510 using the different hidden layers 512, 512B, through 512N in order to provide the output through the output layer 514.

FIG. 6 is a flow diagram illustrating a process 600 for decoding. The process 600 for decoding may be performed by a decoder system (e.g., a chipset, a processor or multiple processors such as an ISP, host processor, application processor, other processor, and/or other component). With reference to FIGS. 1-7, in some examples, the decoder system can include, for example, the auto-regressive transformer model of FIG. 1, the auto-regressive transformer model of FIG. 2, the weight tensor W_{Q} 110 for query projection of FIG. 1, the weight tensor W_{K} 120 for key projection of FIG. 1, the weight tensor W_{V} 130 for value projection of FIG. 1, the attention blocks 140A-140C of FIG. 1, the weight tensor Wₚᵣₒⱼ 170 for projection of FIG. 1, the weight tensor W_{Q} 210 for query projection of FIG. 2, the weight tensor W_{K} 220 for key projection of FIG. 2, the weight tensor W_{V} 230 for value projection of FIG. 2, the attention block 240 of FIG. 2, the weight tensor Wₚᵣₒⱼ 270 for projection of FIG. 2, the buffer 330 of FIG. 3, the framer 335 of FIG. 3, the system 400 of FIG. 4, the encoder 410 of FIG. 4, the decoder 420 of FIG. 4, the neural network 500, a computing system (e.g., 700 in FIG. 7), a system, an apparatus, a device, a non-transitory computer readable medium having stored thereon a program to be performed using a processor, or a combination thereof. In some examples, the imaging system includes a display. In some examples, the decoder system includes a transceiver and/or other communication interface(s).

At operation 605, the decoder system (or component(s) thereof) is configured to, and can, receive an input token.

In some examples, the input token of operation 605 can include at least one of the input tokens 105A-105C of FIG. 1 and/or the input tokens 205A-205C of FIG. 2. In some examples, the input token of operation 605 can include data from, or based on, the context tensor 415 output by the encoder 410 of FIG. 4. In some examples, the input token of operation 605 can include data from, or based on, the input 405 of FIG. 4. In some examples, the input token is a tensor, such as a vector, a matrix, or a tensor with 3 or more dimensions.

At operation 610, the decoder system (or component(s) thereof) is configured to, and can, apply a projection tensor to the input token to generate a feature tensor.

In some examples, the projection tensor includes at least one of the weight tensor W_{Q} 110 for query projection of FIG. 1, the weight tensor W_{K} 120 for key projection of FIG. 1, the weight tensor W_{V} 130 for value projection of FIG. 1, the weight tensor Wₚᵣₒⱼ 170 for projection of FIG. 1, the weight tensor W_{Q} 210 for query projection of FIG. 2, the weight tensor W_{K} 220 for key projection of FIG. 2, the weight tensor W_{V} 230 for value projection of FIG. 2, the weight tensor Wₚᵣₒⱼ 270 for projection of FIG. 2, or a combination thereof. In some examples, the feature tensor includes at least one query (e.g., query 115A-115C of FIG. 1, query 215A-215C of FIG. 2), at least one key (e.g., key 125A-125C of FIG. 1, key 225A-225C of FIG. 2), at least one value (value 135A-135C of FIG. 1, value 235A-235C of FIG. 2), at least one feature (e.g., feature tensor 305-315 of FIG. 3), data stored in a buffer (e.g., buffer 330 associated with the framer 335 of FIG. 3, key buffer associated with the key framer 280 of FIG. 2, value buffer associated with the value framer 285 of FIG. 2), or a combination thereof. The projection tensor is a tensor. In some examples, the projection tensor can be a projection vector, a projection matrix, or a tensor with 3 or more dimensions.

In some examples, the decoder system (or component(s) thereof) is configured to, and can, store the feature tensor in the buffer (e.g., as in the key framer 280 of FIG. 2, the value framer 285 of FIG. 2, or the framer 335 of FIG. 3). In some examples, the decoder system (or component(s) thereof) is configured to, and can, overwrite an invalid portion of the buffer (e.g., storing zero, negative infinity, infinity, “undefined,” or another specified value indicative of invalid data) (e.g., the invalid portion 325 of the buffer 330 of FIG. 3) with the feature tensor to store the feature tensor in the buffer.

In some examples, the decoder system (or component(s) thereof) is configured to, and can, discard an oldest feature tensor from the buffer before storing the feature tensor in the buffer. The oldest feature tensor is an oldest one of a plurality of feature tensors stored in the buffer. The plurality of feature tensors includes the at least one previous feature tensor. For instance, in the context of FIG. 2, for an iteration where the iteration t is greater than T (t>T), the key framer 280 can overwrite an oldest key of the previous keys stored in the key buffer to store a new key (e.g., key 225C). Similarly, again in the context of FIG. 2, for an iteration where the iteration t is greater than T (t>T), the value framer 285 can overwrite an oldest value of the previous values stored in the value buffer to store a new value (e.g., value 235C). In the context of FIG. 3, once the framer 335 fills up the buffer 330 completely with features and needs to add a new feature, the framer 335 can overwrite an oldest feature of the previous features stored in the buffer 330 (e.g. the feature tensor 315) to store the new feature.

In some examples, the decoder system (or component(s) thereof) is configured to, and can, discard a least important feature tensor from the buffer before storing the feature tensor in the buffer. A plurality of feature tensors stored in the buffer correspond to a plurality of importance metrics. The least important feature tensor of the plurality of feature tensors corresponds to a lowest importance metric of the plurality of importance metrics. The plurality of feature tensors including the at least one previous feature tensor. For instance, in the context of FIG. 2, the key framer 280 can determine importance metrics for each of the keys stored in the key buffer, and for an iteration where the iteration t is greater than T (t>T), the key framer 280 can overwrite a least important key according to the importance metrics (or an oldest key of a set of least important keys) of the previous keys stored in the key buffer to store a new key (e.g., key 225C). Similarly, again in the context of FIG. 2, the value framer 285 can determine importance metrics for each of the values stored in the value buffer, and for an iteration where the iteration t is greater than T (t>T), the value buffer can overwrite a least important value according to the importance metrics (or an oldest value of a set of least important values) of the previous values stored in the value buffer to store a new value (e.g., value 235C). In the context of FIG. 3, the framer 335 can determine importance metrics for each of the features stored in the buffer 330, and once the framer 335 fills up the buffer 330 completely with features and needs to add a new feature, the framer 335 can overwrite a least important feature according to the importance metrics (or an oldest feature of a set of least important features) of the previous features stored in the feature buffer to store the new feature.

At operation 615, the decoder system (or component(s) thereof) is configured to, and can, process at least the feature tensor and at least one previous feature tensor using at least one attention calculation to generate an output token. The at least one previous feature tensor is retrieved from a buffer. The at least one previous feature tensor is previously calculated based on application of the projection tensor to a previous input token.

In some examples, the attention calculation includes at least one of the calculations in the attention blocks 140A-140C of FIG. 1, a scaling operation according to the scaling factor dₖ 145 of FIG. 1, a masking operation according to one of the masks 150A-150C of FIG. 1, a normalization operation using the softmax function σ 155 of FIG. 1, application of the weight tensor Wₚᵣₒⱼ 170 for projection of FIG. 1, at least one of the calculations in the attention block 240 of FIG. 2, a scaling operation according to the scaling factor dₖ 245 of FIG. 2, a masking operation according to one of the masks 250A-250C of FIG. 2, a normalization operation using the softmax function σ 255 of FIG. 2, application of the weight tensor Wₚᵣₒⱼ 270 for projection of FIG. 2, a matrix multiplication operation, a dot product multiplication operation, an addition operation, a calculation performed using the framer 335 of FIG. 3, a calculation performed using the system 400 of FIG. 4, a calculation performed using the encoder 410 of FIG. 4, a calculation performed using the decoder 420 of FIG. 4, or a combination thereof.

Examples of the buffer include the key buffer associated with the key framer 280 of FIG. 2, the value buffer associated with the value framer 285 of FIG. 2, the buffer 330 associated with the framer 335 of FIG. 3, or a combination thereof. Examples of the at least one previous feature tensor include keys or values from earlier iterations than a current iteration from the key buffer or value buffer, earlier feature tensors, or a combination thereof. For instance, with reference to FIG. 2, for the iteration 200C, the key 225C and the value 235C represent examples of the feature tensor generated in operation 610, while the at least one previous feature tensor can include previous keys generated in earlier iterations and stored by the key framer 280 in the key buffer (e.g., key 225A, key 225B) and/or previous values generated in earlier iterations and stored by the value framer 285 in the value buffer (e.g., value 235A, value 235B). With reference to FIG. 3, for an iteration t where t=i, the feature tensor 305 is an example of the feature tensor generated in operation 610, while the at least one previous feature tensor can include the feature tensor 310 associated with t=i−1 and/or feature tensor 315 associated with t=i−2.

With reference to FIGS. 1-2, in some examples, the feature tensor generated in operation 610 is a key feature tensor (e.g., one of the keys 125A-125C or one of the keys 225A-225C), the projection tensor is a key projection tensor (e.g., the weight tensor W_{K} 120 for key projection or the weight tensor W_{K} 220 for key projection), the buffer is a key buffer (e.g., corresponding to the key framer 280), or a combination thereof. Again with reference to FIGS. 1-2, in some examples, the feature tensor generated in operation 610 is a value feature tensor (e.g., one of the values 135A-135C or one of the values 235A-235C), the projection tensor is a value projection tensor (e.g., the weight tensor W_{V} 130 for value projection or the weight tensor W_{V} 230 for value projection), the buffer is a value buffer (e.g., corresponding to the value framer 285), or a combination thereof.

With reference to FIG. 4, in some examples, the decoder system (or component(s) thereof) is configured to, and can, output an output (e.g., output 425) that is based on at least the output token generated in operation 615. With reference to FIGS. 1-2, the output token can refer to one of the output tokens of the set of output tokens 175A-175C and/or the set of output tokens 275A-275C. In some examples, the output includes the output token. In some examples, the output is the output token. In some examples, the decoder system (or component(s) thereof) is configured to, and can, generate the output based on the output token before outputting the output. In some examples, the decoder system (or component(s) thereof) is configured to, and can, process the output token (and/or one or more additional output token(s)) to generate the output. In some examples, the decoder system (or component(s) thereof) is configured to, and can, combine the output token with one or more additional output token(s) (and/or process the combination) to generate the output. For instance, with reference to FIGS. 1-2, in some examples, the decoder system (or component(s) thereof) is configured to, and can, combine multiple output tokens of the output tokens 175A-175C and/or of the output tokens 275A-275C (and/or process the combination) to generate the output.

In some examples, the decoder system (or component(s) thereof) is configured to, and can, receive a second input token. The decoder system (or component(s) thereof) can apply the projection tensor to the second input token to generate a second feature tensor. The decoder system (or component(s) thereof) can process at least the second feature tensor, the feature tensor, and/or the at least one previous feature tensor using the at least one attention calculation to generate a second output token. The feature tensor and the at least one previous feature tensor can be retrieved from the buffer. For instance, the second input token can be an input token from a later iteration than the input token, and the second feature tensor can be a feature tensor from a later iteration than the feature tensor. For instance, with reference to FIG. 1, in an illustrative example, the at least one previous feature tensor can refer to the key 125A or the value 135A, the input token can refer to the input token 105B, the feature tensor can refer to the key 125B or the value 135B, the output token can refer to the output token 175B, the second input token can refer to the input token 105C, the second feature tensor can refer to the key 125C or the value 135C, and the second output token can refer to the output token 175C. With reference to FIG. 2, in an illustrative example, the at least one previous feature tensor can refer to the key 225A or the value 235A, the input token can refer to the input token 205B, the feature tensor can refer to the key 225B or the value 235B, the output token can refer to the output token 275B, the second input token can refer to the input token 205C, the second feature tensor can refer to the key 225C or the value 235C, and the second output token can refer to the output token 275C. With reference to FIG. 3, in an illustrative example, the at least one previous feature tensor can refer to the feature tensor 315, the feature tensor can refer to the feature tensor 310, and the second feature tensor can refer to the feature tensor 305.

With reference to FIG. 4, in some examples, the decoder system (or component(s) thereof) is configured to, and can, output an output (e.g., output 425) that is based on at least the output token and the second output token. With reference to FIGS. 1-2, the output token and the second output token can refer to two different output tokens of the set of output tokens 175A-175C and/or the set of output tokens 275A-275C. In some examples, the output includes the output token and/or the second output token. In some examples, the output is the output token and/or the second output token. In some examples, the decoder system (or component(s) thereof) is configured to, and can, generate the output based on the output token and the second output token before outputting the output. In some examples, the decoder system (or component(s) thereof) is configured to, and can, process the output token and/or the second output token (and/or one or more additional output token(s)) to generate the output. In some examples, the decoder system (or component(s) thereof) is configured to, and can, combine the output token with the second output token and/or one or more additional output token(s) (and/or process the combination) to generate the output. For instance, with reference to FIGS. 1-2, in some examples, the decoder system (or component(s) thereof) is configured to, and can, combine multiple output tokens of the output tokens 175A-175C and/or of the output tokens 275A-275C (and/or process the combination) to generate the output.

In some examples, the decoder system (or component(s) thereof) is configured to, and can, retrieve the at least one previous feature tensor from the buffer. For instance, with reference to FIG. 3, if the feature tensor generated in operation 610 is the feature tensor 305 associated with the iteration t=i, then the at least one previous feature tensor can be retrieved by the framer 335 from the valid portion 320 of the buffer 330 and can include the feature tensor 310 associated with the iteration t=i−1 and/or the feature tensor 315 associated with the iteration t=i−2.

In some examples, the input token is based on an output of an encoder (e.g., encoder 410 of FIG. 4). For instance, the output of the encoder can include a context tensor (e.g., context tensor 415 of FIG. 4). In some examples, the output of the encoder (e.g., the context tensor 415 of FIG. 4) includes the input token (e.g., any of the input tokens 105A-105C of FIG. 1 and/or any of the input tokens 205A-205C). In some examples, the input token is generated (e.g., by the decoder 420 and/or the encoder 410 of FIG. 4) based on data from the output of the encoder (e.g., the context tensor 415 of FIG. 4), for instance by processing, combining, and/or selecting data from the output of the encoder to generate the input token. In some examples, the at least one attention calculation (of operation 615) and the projection tensor (of operation 610) are part of a decoder (e.g., decoder 420). In some examples, the output (e.g., the output 425 of FIG. 4) of the decoder (e.g., the decoder 420 of FIG. 4) is based on the output token. In some examples, the decoder system (or component(s) thereof) includes a decoder (e.g., decoder 420), an encoder (e.g., encoder 410), or a combination thereof (e.g., an autoencoder and/or codec and/or the system 400 of FIG. 4). In some examples, the decoder system (or component(s) thereof) is configured to, and can, generate the output of the encoder (e.g., the context tensor 415 of FIG. 4) using the encoder (e.g., the encoder 410 of FIG. 4).

In some examples, an input (e.g., input 405 of FIG. 4) of the encoder (e.g., encoder 410) includes a first string of text, and an output (e.g., output 425) of the decoder (e.g., decoder 420) includes a second string of text that is based on the first string of text. In some examples, the second string of text is conversationally responsive to the first string of text. For example, the second string of text can represent an artificially intelligence (AI) chatbot or AI assistant that responds to a request, query, or other message from a user (or another AI chatbot or AI assistant) in the first string of text. In some examples, the first string of text is in a first language, and the second string of text is a translation of the first string of text from the first language to a second language. The languages can include written languages, spoken languages, programming languages, markup languages, or a combination thereof. In some examples, the first string of text has a first length (e.g., a first number of characters), and the second string of text is a summary of the first string of text having a second length (e.g., a second number of characters) that is shorter than the first length (e.g., the second number of characters is less than the first number of characters). In some examples, the first string of text represents an incomplete message (e.g., an incomplete sentence, paragraph, search query, and/or email), and the second string of text automatically completes the incomplete message in the first string of text (e.g., including additional text to fill in the missing portion of the incomplete sentence, paragraph, search query, email, and/or message).

In some examples, the at least one attention calculation receives three inputs including a query input (e.g., at least one of the queries 115A-115C of FIG. 1 and/or of the queries 215A-215C of FIG. 2) and a key input (e.g., at least one of the keys 125A-125C of FIG. 1 and/or of the keys 225A-225C of FIG. 2) and a value input (e.g., at least one of the values 135A-135C of FIG. 1 and/or of the values 235A-235C of FIG. 2), and one of the three inputs includes at least the feature tensor (received in operation 605) and the at least one previous feature tensor (of operation 615). For instance, in a first illustrative example, the feature tensor and the at least one previous feature tensor can represent queries (e.g., a plurality of the queries 115A-115C of FIG. 1 and/or of the queries 215A-215C of FIG. 2). In a second illustrative example, the feature tensor and the at least one previous feature tensor can represent keys (e.g., a plurality of the keys 125A-125C of FIG. 1 and/or of the keys 225A-225C of FIG. 2). In a third illustrative example, the feature tensor and the at least one previous feature tensor can represent values (e.g., a plurality of the values 135A-135C of FIG. 1 and/or of the values 235A-235C of FIG. 2).

In some examples, the at least one attention calculation includes a scaling function that uses a scaling factor dₖ (e.g., scaling factor dₖ 145 of FIG. 1 and/or scaling factor dₖ 245 of FIG. 2). For instance, the scaling function can include a division by \sqrt{dₖ}. In some examples, the at least one attention calculation includes a mask (e.g., at least one of the masks 150A-150C of FIG. 1 and/or of the masks 250A-250C of FIG. 2) that is configured to, and can, confine an attention span. In some examples, the mask is dependent on an iteration (e.g., a value of t in any of FIGS. 1-3, one of the iterations 100A-100C of FIG. 1, and/or one of the iterations 200A-200C of FIG. 2) of the at least one attention calculation. In some examples, the at least one attention calculation includes a softmax function (e.g., softmax function σ 155 of FIG. 1 and/or softmax function σ 255 of FIG. 2) configured to normalize at least one weight value. In some examples, the at least one attention calculation includes a combination of one or more multiplications (e.g., dot product multiplications, matrix multiplications), one or more additions, one or more scaling functions, one or more masks, and/or one or more softmax functions, for instance as combined in Equation 4, in the attention blocks 140A-140C of FIG. 1, and/or in the attention block 240 of FIG. 2.

In some examples, an inference graph associated with the at least one attention calculation is static. For instance, with reference to FIG. 2, the sizes of various tensors (e.g., input tokens 205A-205C, queries 215A-215C, keys 225A-225C, values 235A-235C, attention scores 260A-260C of FIG. 2 masks 250A-250C, intermediate activations 165A-165C, output tokens 175A-175C), and/or the calculations to be performed therewith, can be consistent (e.g., static) across iterations (e.g., across different iterations 200A-200C and corresponding values of t) of the attention calculation (e.g., across the attention block 240 and/or the auto-regressive transformer model of FIG. 2 more broadly).

In some examples, the decoder system (or component(s) thereof) is configured to, and can, initialize the buffer to be sized according to a first dimension and a second dimension. For instance, with reference to FIG. 2, the key buffer and the value buffer both have a size of T×512, with T representing the first dimension of each buffer and 512 representing the second dimension of each buffer, respectively. The first dimension of the buffer can be based on a maximum context length (e.g., T in FIG. 2), while the second dimension of the buffer (e.g., 512 in FIG. 2) can be based on a size of the input token (e.g., dimensions 1×512 of the input tokens 205A-205C). In an illustrative example, the size of the first dimension of the buffer is equal to the maximum context length (e.g., T in FIG. 2) multiplied by a first dimension of the size of the input token (e.g., the “1” in the dimensions 1×512 of the input tokens 205A-205C of FIG. 2), while the size of the first dimension of the buffer is equal to the second dimension of the size of the input token (e.g., the “512” in the dimensions 1×512 of the input tokens 205A-205C of FIG. 2). For instance, if the size of the input tokens 205A-205C of FIG. 2 was instead 2×1024, then the size of each of the buffers of FIG. 2 (e.g., key buffer and/or value buffer) could instead be 2T×1024.

In some examples, the decoder system (or component(s) thereof) is configured to, and can, maintain a counter (e.g., the counter t in FIGS. 2-3) tracking a number (e.g., an amount) of feature tensors cached in the buffer. In some examples, the decoder system (or component(s) thereof) is configured to, and can, maintain a counter (e.g., the counter t in FIGS. 1-3) tracking a number (e.g., an amount) of iterations of calculations performed using the at least one attention calculation (e.g., attention blocks 140A-140C of FIG. 1 and/or attention block 240 of FIG. 2) and/or an auto-regressive transformer model (e.g., the auto-regressive transformer model of FIG. 1 or the auto-regressive transformer model of FIG. 2). In some examples, the at least one attention calculation can include application of a mask (e.g., one of the masks 150A-150C of FIG. 1 and/or one of the masks 250A-250C of FIG. 2) that is dependent on one of the above-identified counters (e.g., that is iteration-dependent).

In some examples, the decoder system (or component(s) thereof) includes: means for receiving an input token; means for applying a projection tensor to the input token to generate a feature tensor; and means for processing at least the feature tensor and at least one previous feature tensor using at least one attention calculation to generate an output token, the at least one previous feature tensor retrieved from a buffer, and the at least one previous feature tensor previously calculated based on application of the projection tensor to a previous input token. With reference to FIGS. 1-7, in some examples, the means for performing these operations can include, for instance, the auto-regressive transformer model of FIG. 1, the auto-regressive transformer model of FIG. 2, the weight tensor W_{Q} 110 for query projection of FIG. 1, the weight tensor W_{K} 120 for key projection of FIG. 1, the weight tensor W_{V} 130 for value projection of FIG. 1, the attention blocks 140A-140C of FIG. 1, the weight tensor Wₚᵣₒⱼ 170 for projection of FIG. 1, the weight tensor W_{Q} 210 for query projection of FIG. 2, the weight tensor W_{K} 220 for key projection of FIG. 2, the weight tensor W_{V} 230 for value projection of FIG. 2, the attention block 240 of FIG. 2, the weight tensor Wₚᵣₒⱼ 270 for projection of FIG. 3, the buffer 330 of FIG. 3, the framer 335 of FIG. 3, the system 400 of FIG. 4, the encoder 410 of FIG. 4, the decoder 420 of FIG. 4, the neural network 500 of FIG. 5, the decoder system that performs the process 600 of FIG. 6, the computing system 700 of FIG. 7, the processor 710 of FIG. 7, a system, and apparatus, a device, a non-transitory computer readable medium having stored thereon a program to be performed using a processor, or a combination thereof.

In some examples, the processes described herein (e.g., the process of FIG. 1, the process of FIG. 2, the process of FIG. 3, the process of FIG. 4, the process of FIG. 5, the process 600 of FIG. 6, and/or other processes described herein) may be performed by a computing device or apparatus. With reference to FIGS. 1-7, in some examples, the processes described herein can be performed by the auto-regressive transformer model of FIG. 1, the auto-regressive transformer model of FIG. 2, the weight tensor W_{Q} 110 for query projection of FIG. 1, the weight tensor W_{K} 120 for key projection of FIG. 1, the weight tensor W_{V} 130 for value projection of FIG. 1, the attention blocks 140A-140C of FIG. 1, the weight tensor Wₚᵣₒⱼ 170 for projection of FIG. 1, the weight tensor W_{Q} 210 for query projection of FIG. 2, the weight tensor W_{K} 220 for key projection of FIG. 2, the weight tensor W_{V} 230 for value projection of FIG. 2, the attention block 240 of FIG. 2, the weight tensor Wₚᵣₒⱼ 270 for projection of FIG. 2, the buffer 330 of FIG. 3, the framer 335 of FIG. 3, the system 400 of FIG. 4, the encoder 410 of FIG. 4, the decoder 420 of FIG. 4, the neural network 500 of FIG. 5, the decoder system that performs the process 600 of FIG. 6, the computing system 700 of FIG. 7, the processor 710, a system, and apparatus, a device, a non-transitory computer readable medium having stored thereon a program to be performed using a processor, or a combination thereof. In some examples, the imaging system includes a display. In some examples, the imaging system includes a transceiver and/or other communication interface(s).

The computing device can include any suitable device, such as a mobile device (e.g., a mobile phone), a desktop computing device, a tablet computing device, a wearable device (e.g., a VR headset, an AR headset, AR glasses, a network-connected watch or smartwatch, or other wearable device), a server computer, a vehicle or computing device of a vehicle, a robotic device, a television, and/or any other computing device with the resource capabilities to perform the processes described herein. In some cases, the computing device or apparatus may include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device may include a display, a network interface configured to communicate and/or receive the data, any combination thereof, and/or other component(s). The network interface may be configured to communicate and/or receive Internet Protocol (IP) based data or other type of data.

The components of the computing device can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein.

The processes described herein are illustrated as logical flow diagrams, block diagrams, or conceptual diagrams, the operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, the processes described herein may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

FIG. 7 is a diagram illustrating an example of a system for implementing certain aspects of the present technology. In particular, FIG. 7 illustrates an example of computing system 700, which can be for example any computing device making up internal computing system, a remote computing system, a camera, or any component thereof in which the components of the system are in communication with each other using connection 705. Connection 705 can be a physical connection using a bus, or a direct connection into processor 710, such as in a chipset architecture. Connection 705 can also be a virtual connection, networked connection, or logical connection.

In some aspects, computing system 700 is a distributed system in which the functions described in this disclosure can be distributed within a datacenter, multiple data centers, a peer network, etc. In some aspects, one or more of the described system components represents many such components each performing some or all of the function for which the component is described. In some aspects, the components can be physical or virtual devices.

Example system 700 includes at least one processor 810, such as a central processing unit (CPU), graphics processing unit (GPU), neural processing unit (NPU), digital signal processor (DSP), image signal processor (ISP), a field programmable gate array (FPGA), an application specific integrated circuit (ASIC), a microprocessor, a controller, another type of processing unit, another suitable electronic circuit, or a combination thereof. The computing system 800 also includes a connection 705 that couples various system components including system memory 715, such as read-only memory (ROM) 720 and random access memory (RAM) 725 to processor 710. Computing system 700 can include a cache 712 of high-speed memory connected directly with, in close proximity to, or integrated as part of processor 710.

Processor 710 can include any general purpose processor and a hardware service or software service, such as services 732, 734, and 736 stored in storage device 730, configured to control processor 710 as well as a special-purpose processor where software instructions are incorporated into the actual processor design. Processor 710 may essentially be a completely self-contained computing system, containing multiple cores or processors, a bus, memory controller, cache, etc. A multi-core processor may be symmetric or asymmetric.

To enable user interaction, computing system 700 includes an input device 745, which can represent any number of input mechanisms, such as a microphone for speech, a touch-sensitive screen for gesture or graphical input, keyboard, mouse, motion input, speech, etc. Computing system 700 can also include output device 735, which can be one or more of a number of output mechanisms. In some instances, multimodal systems can enable a user to provide multiple types of input/output to communicate with computing system 700. Computing system 700 can include communications interface 740, which can generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a radio-frequency identification (RFID) wireless signal transfer, near-field communications (NFC) wireless signal transfer, dedicated short range communication (DSRC) wireless signal transfer, 702.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communications interface 740 may also include one or more Global Navigation Satellite System (GNSS) receivers or transceivers that are used to determine a location of the computing system 700 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 730 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (L1/L2/L3/L4/L5/L #), resistive random-access memory (RRAM/ReRAM), phase change memory (PCM), spin transfer torque RAM (STT-RAM), another memory chip or cartridge, and/or a combination thereof.

The storage device 730 can include software services, servers, services, etc., that when the code that defines such software is executed by the processor 710, it causes the system to perform a function. In some aspects, a hardware service that performs a particular function can include the software component stored in a computer-readable medium in connection with the necessary hardware components, such as processor 710, connection 705, output device 735, etc., to carry out the function.

As used herein, the term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted using any suitable means including memory sharing, message passing, token passing, network transmission, or the like.

In some aspects, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Specific details are provided in the description above to provide a thorough understanding of the aspects and examples provided herein. However, it will be understood by one of ordinary skill in the art that the aspects may be practiced without these specific details. For clarity of explanation, in some instances the present technology may be presented as including individual functional blocks including functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc. Examples of computer-readable media that may be used to store instructions, information used, and/or information created during methods according to described examples include magnetic or optical disks, flash memory, USB devices provided with non-volatile memory, networked storage devices, and so on.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific aspects thereof, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

One of ordinary skill will appreciate that the less than (“<”) and greater than (“>”) symbols or terminology used herein can be replaced with less than or equal to (“≤”) and greater than or equal to (“>”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” means A, B, or A and B. In another example, claim language reciting “at least one of A, B, and C” means A, B, C, or A and B, or A and C, or B and C, or A and B and C. The language “at least one of” a set and/or “one or more” of a set does not limit the set to the items listed in the set. For example, claim language reciting “at least one of A and B” can mean A, B, or A and B, and can additionally include items not listed in the set of A and B.

The various illustrative logical blocks, modules, circuits, and algorithm steps described in connection with the aspects disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software modules or hardware modules configured for encoding and decoding, or incorporated in a combined video encoder-decoder (CODEC).

Claim language or other language reciting “at least one processor configured to,” “at least one processor being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Illustrative aspects of the disclosure include:

Aspect 1. An apparatus for cached decoding, the apparatus comprising: a memory; and at least one processor (e.g., implemented in circuitry) coupled to the memory and configured to: receive an input token; apply a projection tensor to the input token to generate a feature tensor; and process at least the feature tensor and at least one previous feature tensor using at least one attention calculation to generate an output token, the at least one previous feature tensor retrieved from a buffer, and the at least one previous feature tensor previously calculated based on application of the projection tensor to a previous input token.

Aspect 2. The apparatus of Aspect 1, wherein the feature tensor is a key feature tensor, wherein the projection tensor is a key projection tensor, and wherein the buffer is a key buffer.

Aspect 3. The apparatus of any of Aspects 1 to 2, wherein the feature tensor is a value feature tensor, wherein the projection tensor is a value projection tensor, and wherein the buffer is a value buffer.

Aspect 4. The apparatus of any of Aspects 1 to 3, wherein the at least one processor is configured to: output an output that is based on at least the output token.

Aspect 5. The apparatus of any of Aspects 1 to 4, wherein the at least one processor is configured to: store the feature tensor in the buffer.

Aspect 6. The apparatus of Aspect 5, wherein the at least one processor is configured to: overwrite an invalid portion of the buffer with the feature tensor to store the feature tensor in the buffer.

Aspect 7. The apparatus of any of Aspects 5 to 6, wherein the at least one processor is configured to: discard an oldest feature tensor from the buffer before storing the feature tensor in the buffer, wherein the oldest feature tensor is an oldest one of a plurality of feature tensors stored in the buffer, the plurality of feature tensors including the at least one previous feature tensor.

Aspect 8. The apparatus of any of Aspects 5 to 7, wherein the at least one processor is configured to: receive a second input token; apply the projection tensor to the second input token to generate a second feature tensor; and process at least the second feature tensor, the feature tensor, and the at least one previous feature tensor using the at least one attention calculation to generate a second output token, the feature tensor and the at least one previous feature tensor retrieved from the buffer.

Aspect 9. The apparatus of Aspect 8, wherein the at least one processor is configured to: output an output that is based on at least the output token and the second output token.

Aspect 10. The apparatus of any of Aspects 1 to 9, wherein the at least one processor is configured to: retrieve the at least one previous feature tensor from the buffer.

Aspect 11. The apparatus of any of Aspects 1 to 10, wherein the input token is based on an output of an encoder, wherein the at least one attention calculation and the projection tensor are part of a decoder.

Aspect 12. The apparatus of Aspect 11, further comprising: the decoder, wherein an output of the decoder is based on the output token.

Aspect 13. The apparatus of any of Aspects 11 to 12, further comprising: the encoder.

Aspect 14. The apparatus of any of Aspects 11 to 13, wherein an input of the encoder includes a first string of text, wherein an output of the decoder includes a second string of text that is based on the first string of text.

Aspect 15. The apparatus of Aspect 14, wherein the second string of text is conversationally responsive to the first string of text.

Aspect 16. The apparatus of any of Aspects 14 to 15, wherein the first string of text is in a first language, wherein the second string of text is a translation of the first string of text from the first language to a second language.

Aspect 17. The apparatus of any of Aspects 1 to 16, wherein the at least one attention calculation receives three inputs, the three inputs including a query input and a key input and a value input, and wherein one of the three inputs includes at least the feature tensor and the at least one previous feature tensor.

Aspect 18. The apparatus of any of Aspects 1 to 17, wherein the at least one attention calculation includes a scaling function that uses a scaling factor dₖ.

Aspect 19. The apparatus of any of Aspects 1 to 18, wherein the at least one attention calculation includes a mask configured to confine an attention span.

Aspect 20. The apparatus of Aspect 19, wherein the mask is dependent on an iteration of the at least one attention calculation.

Aspect 21. The apparatus of any of Aspects 1 to 20, wherein the at least one attention calculation includes a softmax function configured to normalize at least one weight value.

Aspect 22. The apparatus of any of Aspects 1 to 21, wherein an inference graph associated with the at least one attention calculation is static.

Aspect 23. The apparatus of any of Aspects 1 to 22, wherein the at least one processor is configured to: initialize the buffer, wherein the buffer is sized according to a first dimension and a second dimension, wherein the first dimension of the buffer is based on a maximum context length, wherein the second dimension of the buffer is based on a size of the input token.

Aspect 24. The apparatus of any of Aspects 1 to 23, wherein the at least one processor is configured to: maintain a counter tracking a number of feature tensors cached in the buffer.

Aspect 25. The apparatus of any of Aspects 1 to 24, wherein the at least one processor is configured to: maintain a counter tracking a number of iterations of the at least one attention calculation.

Aspect 26. The apparatus of any of Aspects 1 to 25, wherein the apparatus includes at least one of a head-mounted display (HMD), a mobile handset, or a wireless communication device.

Aspect 27. A method for cached decoding, the method comprising: receiving an input token; applying a projection tensor to the input token to generate a feature tensor; and processing at least the feature tensor and at least one previous feature tensor using at least one attention calculation to generate an output token, the at least one previous feature tensor retrieved from a buffer, and the at least one previous feature tensor previously calculated based on application of the projection tensor to a previous input token.

Aspect 28. The method of Aspect 27, wherein the feature tensor is a key feature tensor, wherein the projection tensor is a key projection tensor, and wherein the buffer is a key buffer.

Aspect 29. The method of any of Aspects 27 to 28, wherein the feature tensor is a value feature tensor, wherein the projection tensor is a value projection tensor, and wherein the buffer is a value buffer.

Aspect 30. The method of any of Aspects 27 to 29, further comprising: outputting an output that is based on at least the output token.

Aspect 31. The method of any of Aspects 27 to 30, further comprising: storing the feature tensor in the buffer.

Aspect 32. The method of Aspect 31, further comprising: overwriting an invalid portion of the buffer with the feature tensor to store the feature tensor in the buffer.

Aspect 33. The method of any of Aspects 31 to 32, further comprising: discarding an oldest feature tensor from the buffer before storing the feature tensor in the buffer, wherein the oldest feature tensor is an oldest one of a plurality of feature tensors stored in the buffer, the plurality of feature tensors including the at least one previous feature tensor.

Aspect 34. The method of any of Aspects 27 to 33, further comprising: receiving a second input token; applying the projection tensor to the second input token to generate a second feature tensor; and processing at least the second feature tensor, the feature tensor, and the at least one previous feature tensor using the at least one attention calculation to generate a second output token, the feature tensor and the at least one previous feature tensor retrieved from the buffer.

Aspect 35. The method of Aspect 34, further comprising: outputting an output that is based on at least the output token and the second output token.

Aspect 36. The method of any of Aspects 27 to 35, further comprising: retrieving the at least one previous feature tensor from the buffer.

Aspect 37. The method of any of Aspects 27 to 36, wherein the input token is based on an output of an encoder, wherein the at least one attention calculation and the projection tensor are part of a decoder.

Aspect 38. The method of Aspect 37, wherein an output of a decoder is based on the output token.

Aspect 39. The method of any of Aspects 37 to 38, further comprising: generating the output of the encoder using the encoder.

Aspect 40. The method of any of Aspects 37 to 39, wherein an input of the encoder includes a first string of text, wherein an output of the decoder includes a second string of text that is based on the first string of text.

Aspect 41. The method of Aspect 40, wherein the second string of text is conversationally responsive to the first string of text.

Aspect 42. The method of any of Aspects 40 to 41, wherein the first string of text is in a first language, wherein the second string of text is a translation of the first string of text from the first language to a second language.

Aspect 43. The method of any of Aspects 27 to 42, wherein the at least one attention calculation receives three inputs, the three inputs including a query input and a key input and a value input, and wherein one of the three inputs includes at least the feature tensor and the at least one previous feature tensor.

Aspect 44. The method of any of Aspects 27 to 43, wherein the at least one attention calculation includes a scaling function that uses a scaling factor dₖ.

Aspect 45. The method of any of Aspects 27 to 44, wherein the at least one attention calculation includes a mask configured to confine an attention span.

Aspect 46. The method of Aspect 45, wherein the mask is dependent on an iteration of the at least one attention calculation.

Aspect 47. The method of any of Aspects 27 to 46, wherein the at least one attention calculation includes a softmax function configured to normalize at least one weight value.

Aspect 48. The method of any of Aspects 27 to 47, wherein an inference graph associated with the at least one attention calculation is static.

Aspect 49. The method of any of Aspects 27 to 48, further comprising: initializing the buffer, wherein the buffer is sized according to a first dimension and a second dimension, wherein the first dimension of the buffer is based on a maximum context length, wherein the second dimension of the buffer is based on a size of the input token.

Aspect 50. The method of any of Aspects 27 to 49, further comprising: maintaining a counter tracking a number of feature tensors cached in the buffer.

Aspect 51. The method of any of Aspects 27 to 50, further comprising: maintaining a counter tracking a number of iterations of the at least one attention calculation.

Aspect 52. A non-transitory computer-readable medium having stored thereon instructions that, when executed by one or more processors, cause the one or more processors to perform operations according to any of Aspects 1 to 51.

Aspect 53. An apparatus for imaging, the apparatus comprising one or more means for performing operations according to any of Aspects 1 to 51.

What is claimed is:

1. An apparatus for cached decoding, the apparatus comprising:
at least one memory; and
at least one processor coupled to the at least one memory and configured to:
receive an input token;
apply a projection tensor to the input token to generate a feature tensor; and
process at least the feature tensor and at least one previous feature tensor using at least one attention calculation to generate an output token, the at least one previous feature tensor retrieved from a buffer, and the at least one previous feature tensor previously calculated based on application of the projection tensor to a previous input token.

2. The apparatus of claim 1,
wherein the feature tensor is a key feature tensor,
wherein the projection tensor is a key projection tensor, and
wherein the buffer is a key buffer.

3. The apparatus of claim 1,
wherein the feature tensor is a value feature tensor,
wherein the projection tensor is a value projection tensor, and
wherein the buffer is a value buffer.

4. The apparatus of claim 1, wherein the at least one processor is configured to:
output an output that is based on at least the output token.

5. The apparatus of claim 1, wherein the at least one processor is configured to:
store the feature tensor in the buffer.

6. The apparatus of claim 5, wherein the at least one processor is configured to:
overwrite an invalid portion of the buffer with the feature tensor to store the feature tensor in the buffer.

7. The apparatus of claim 5, wherein the at least one processor is configured to:
discard an oldest feature tensor from the buffer before storing the feature tensor in the buffer, wherein the oldest feature tensor is an oldest one of a plurality of feature tensors stored in the buffer, the plurality of feature tensors including the at least one previous feature tensor.

8. The apparatus of claim 1, wherein the at least one processor is configured to:
receive a second input token;
apply the projection tensor to the second input token to generate a second feature tensor; and
process at least the second feature tensor, the feature tensor, and the at least one previous feature tensor using the at least one attention calculation to generate a second output token, the feature tensor and the at least one previous feature tensor retrieved from the buffer.

9. The apparatus of claim 8, wherein the at least one processor is configured to:
output an output that is based on at least the output token and the second output token.

10. The apparatus of claim 1, wherein the at least one processor is configured to:
retrieve the at least one previous feature tensor from the buffer.

11. The apparatus of claim 1, wherein the input token is based on an output of an encoder, wherein the at least one attention calculation and the projection tensor are part of a decoder.

12. The apparatus of claim 11, further comprising:
the decoder, wherein an output of the decoder is based on the output token.

13. The apparatus of claim 11,
wherein an input of the encoder includes a first string of text,
wherein an output of the decoder includes a second string of text that is based on the first string of text.

14. The apparatus of claim 1,
wherein the at least one attention calculation receives three inputs, the three inputs including a query input and a key input and a value input, and
wherein one of the three inputs includes at least the feature tensor and the at least one previous feature tensor.

15. The apparatus of claim 1, wherein the at least one attention calculation includes a scaling function that uses a scaling factor dₖ.

16. The apparatus of claim 1, wherein the at least one attention calculation includes a mask configured to confine an attention span.

17. The apparatus of claim 16, wherein the mask is dependent on an iteration of the at least one attention calculation.

18. The apparatus of claim 1, wherein the at least one attention calculation includes a softmax function configured to normalize at least one weight value.

19. The apparatus of claim 1, wherein an inference graph associated with the at least one attention calculation is static.

20. The apparatus of claim 1, wherein the at least one processor is configured to:
initialize the buffer, wherein the buffer is sized according to a first dimension and a second dimension, wherein the first dimension of the buffer is based on a maximum context length, wherein the second dimension of the buffer is based on a size of the input token.

21. The apparatus of claim 1, wherein the at least one processor is configured to:
maintain a counter tracking a number of feature tensors cached in the buffer.

22. The apparatus of claim 1, wherein the at least one processor is configured to:
maintain a counter tracking a number of iterations of the at least one attention calculation.

23. A method for cached decoding, the method comprising:
receiving an input token;
applying a projection tensor to the input token to generate a feature tensor; and
processing at least the feature tensor and at least one previous feature tensor using at least one attention calculation to generate an output token, the at least one previous feature tensor retrieved from a buffer, and the at least one previous feature tensor previously calculated based on application of the projection tensor to a previous input token.

24. The method of claim 23, wherein the feature tensor is a key feature tensor, wherein the projection tensor is a key projection tensor, and wherein the buffer is a key buffer.

25. The method of claim 23, wherein the feature tensor is a value feature tensor, wherein the projection tensor is a value projection tensor, and wherein the buffer is a value buffer.

26. The method of claim 23, further comprising:
outputting an output that is based on at least the output token.

27. The method of claim 23, further comprising:
storing the feature tensor in the buffer.

28. The method of claim 27, further comprising:
overwriting an invalid portion of the buffer with the feature tensor to store the feature tensor in the buffer.

29. The method of claim 27, further comprising:
discarding an oldest feature tensor from the buffer before storing the feature tensor in the buffer, wherein the oldest feature tensor is an oldest one of a plurality of feature tensors stored in the buffer, the plurality of feature tensors including the at least one previous feature tensor.

30. The method of claim 27, further comprising:
retrieving the at least one previous feature tensor from the buffer.
